(19) United States
(12) Patent Application Publication
(10) Pub. No.: US 2010/0147929 A1
(43) Pub. Date: Jun. 17, 2010

(54) METHOD FOR JOINING METALS

(76) Inventor: Scott COOK, Broken Arrow, OK (US)

Correspondence Address: The BOC Group, Inc., 575 MOUNTAIN AVENUE, MURRAY HILL, NJ, 07974-2082, US

(21) Appl. No.: 12/335,800

(22) Filed: Dec. 16, 2008

(51) Int. Cl. B23K 31/02; E04B 1/682

(52) U.S. Cl. 228/194; 277/316

(57) ABSTRACT

A method for joining two large metal surfaces together by inserting a gasket or coating between two sheets of metal and heating to a temperature above the eutectic temperature of gasket or coating and the metal surfaces. This heating will cause the metal surfaces to fuse weld together while being heated to a point below their melting point

### BACKGROUND OF THE INVENTION

The present invention provides for a method for joining metals together.

There are a variety of techniques used to join two metal surfaces together. These can include welding, brazing, soldering and riveting. Welding involves heating the parts to be joined to a temperature above their melting point. Molten metal is added to joint between the heated surfaces and then the whole assemblage is allowed to cool to room temperature.

When manufacturing large items such as pressure vessels, there are significant amounts of welding operations to be performed. This results in a large amount of time spent welding and in inspection and post-weld treatments. This raises the cost of the fabrication of the large item considerably.

The present invention will lessen the cost of manufacturing large metal items by a process whereby two metal surfaces can be joined together through a fusing process rather than traditional welding techniques.

### SUMMARY OF THE INVENTION

In one embodiment of the present invention there is disclosed a method for joining two surfaces together comprising inserting a gasket between the surfaces, heating the surfaces and the gasket to a temperature above the eutectic temperature of the gasket and the surfaces, and allowing the surfaces to cool.

In a further embodiment of the present invention, there is disclosed a method for joining two surfaces together comprising applying a coating to at least one of the surfaces, heating the surfaces and the coating to a temperature above the eutectic temperature of the coating and the surfaces, and allowing the surfaces to cool.

The present invention relates to a method for fuse welding two surfaces together at a temperature below the melting point of the two surfaces. A gasket is placed between the two surfaces to be joined. The gasket contains material such as an excess of alloying material. The surfaces and gasket are heated together and the material from the gasket dissolves and diffuses into the mating surface by reducing their eutectic temperature and capillary forces to spread out.

The present invention is directed primarily to the joining of iron-containing metals but can be employed for a variety of other metals and alloys such as aluminum, nickel, copper and other metals commonly used in industry.

### DETAILED DESCRIPTION OF THE INVENTION

The present invention provides for a method of joining two or more large metal surfaces together. The metal surfaces are fused together by placing a gasket or a coating between the surfaces and heating to a temperature above the eutectic temperature of the combination of the gasket and the surfaces but below the melting point of the metal surfaces.

Once the surfaces and the gasket reach their eutectic temperature, the two surfaces will weld together and can then be allowed to cool. For example, two surfaces and a eutectic weld gasket containing an excess of alloying material are placed in an oven. The oven would then be heated to a temperature above the eutectic point of the gasket, but below the melting point of the surfaces to be welded together. The gasket and mating layer of the surfaces would melt together. Due to the localized nature of the weld, capillary forces should prevent any dripping or runoff of the melted material away from the weld location.

Alternatively, the gasket could be replaced by a coating. The coating would contain the excess of alloying material and can be applied to one or both surfaces to be mated together. The two surfaces to be mated would be heated by induction heating or in an oven to the eutectic temperature where they will bond together. The coating will also not drip or runoff due to the capillary action between the surfaces.

This use of a coating further eases installation of the larger surfaces to be joined and also reduces the need for extra equipment to apply the gasket.

Additionally a weight or clamping mechanism could also be applied to the two surfaces to be joined together prior to their being heated.

Surface treatments like those that are performed before brazing operations could be employed depending upon the type and nature of the surfaces to be joined. A part could be subjected to a special surface treatment containing the alloying element. For example, a gear could be surface treated while the shaft it is mated to is not.

Examples of some eutectic alloys are eutectic alloys for solder containing tin, lead and sometimes silver or gold. Casting alloys such as aluminum-silicon could also be considered.

The methods of the present invention can be used for joining large scale vessels but can also be employed in joining plate and sheet metal.

In practicing the methods of the present invention, a first embodiment would be where the two faces of the metal materials to be joined are the same. In this situation, the gasket or coating material would be like the metal materials to be joined but may also contain the alloying compound which would lower the melting temperatures of the two faces to the eutectic temperature.

In a second embodiment of the present invention, two materials can be joined that are not the same composition and which readily alloy together. In this situation, the gasket or coating is comprised of a material that will coincide with eutectic invariant point of the mixture of the two dissimilar materials.

In a binary eutectic system, such as a copper-silver system, there are relative amounts of solubility of one metal into the other depending upon the temperature to which the two solid phases are subjected to. There is a temperature at which there is limited solid-solid solubility. As such, the addition of silver to copper or copper to silver will reduce the temperature at which complete melting occurs. Each of these situations are found in binary eutectic phase diagrams and be reported as liquidus lines. When the liquidus lines are charted versus the temperature at which there is the limited solid-solid solubility, there is the invariant point where the solid and liquid phases exist in certain concentration in equilibrium.

The present invention may also be employed where the materials to be joined are not the same and do not readily alloy together. Here the gasket or coating material will be a composition that can separately alloy with both materials to be joined. The gasket or coating composition may or may not be laminar at invariant percents to create the eutectic temperature necessary for joining the two dissimilar materials.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for joining two surfaces together comprising inserting a gasket between said surfaces, heating said surfaces and said gasket to a temperature above the eutectic temperature of the gasket and the surfaces, and allowing said surfaces to cool.

2. The method as claimed in claim 1 wherein said two surfaces are metals.

3. The method as claimed in claim 2 wherein said metals are selected from the group consisting of iron-containing metals, aluminum, nickel and copper.

4. The method as claimed in claim 1 wherein said two surfaces are the same composition.

5. The method as claimed in claim 4 wherein the gasket inserted between said two surfaces comprises the same material as the two surfaces and an alloying compound.

6. The method as claimed in claim 1 wherein said two surfaces are different materials that alloy together.

7. The method as claimed in claim 6 wherein the gasket inserted between said two surfaces comprises a mixture of said two different materials.

8. The method as claimed in claim 7 wherein the gasket further comprises an alloying compound.

9. The method as claimed in claim 1 wherein said two surfaces are different materials that do not alloy together.

10. The method as claimed in claim 8 wherein the gasket inserted between said two surfaces comprises a material that will alloy with either of said two surfaces.

11. A method for joining two surfaces together comprising applying a coating to at least one of said surfaces, heating said surfaces and said coating to a temperature above the eutectic temperature of the coating and the surfaces, and allowing said surfaces to cool.

12. The method as claimed in claim 11 wherein said two surfaces are metals.

13. The method as claimed in claim 12 wherein said metals are selected from the group consisting of iron-containing metals, aluminum, nickel and copper.

14. The method as claimed in claim 11 wherein said two surfaces are the same composition.

15. The method as claimed in claim 14 wherein the coating applied to said at least one surface comprises the same material as the two surfaces and an alloying compound.

16. The method as claimed in claim 11 wherein said two surfaces are different materials that alloy together.

17. The method as claimed in claim 16 wherein coating applied to said at least one surface comprises a mixture of said two different materials.

18. The method as claimed in claim 17 wherein said coating further comprises an alloying compound.

19. The method as claimed in claim 10 wherein said two surfaces are different materials that do not alloy together.

20. The method as claimed in claim 17 wherein coating applied to said at least one surface comprises a material that will alloy with either of said two surfaces.
